(19) United States
(12) Patent Application Publication
(10) Pub. No.: US 2026/0037888 A1
(43) Pub. Date: Feb. 5, 2026

(54) AUTOMATED PATIENT REFERRAL MANAGEMENT SYSTEM AND METHOD

(71) Applicant: INNOVACCER INC., San Francicso, CA (US)

(72) Inventors: Kuldeep SINGH, San Francisco, CA (US); Anand Hirekatur, San Francisco, CA (US); Rakshay Jain, San Francisco, CA (US); Abhinav Shashank, San Francisco, CA (US)

(21) Appl. No.: 18/793,338

(22) Filed: Aug. 2, 2024

(51) Int. Cl. G06Q 10/0631; G16H 10/60; G16H 40/20; G16H 80/00

(52) U.S. Cl. CPC G06Q 10/063112

(57) ABSTRACT

Disclosed is a system and method for standalone automated patient referral management. The system comprises an intake module that accepts and processes referrals from diverse referral communication channels as entry points for patient referrals. A processing module undertakes the analysis of patient information to pinpoint a healthcare provider based on a healthcare need, a preference, and a schedule availability. A scheduling module confirms the appointment, and engages in dynamic three-way communication between the patient, the referring entity, and the healthcare provider. A feedback module dispatches feedback to the referring entity, offering a report on an outcome of the appointment. A natural language processing (NLP) module extracts information from conversational speech. The system utilizes algorithms to match patients with the healthcare providers based on criteria including specialty, availability, and patient preferences. A feedback module communicates with the originating EHR systems and provides updates to maintain continuity of care.

### TECHNICAL FIELD

The present disclosure in general relates to an automated patient referral management system and method for automating the entire referral process and sending notifications to the desired person. The present disclosure in particular relates to integrating optical character recognition (OCR), artificial intelligence (AI), and electronic health records (EHR) technology to substantially reduce manual tasks, minimize errors, and ensure a fluid transition of patients from primary to specialist care.

### BACKGROUND

The traditional process of patient referrals is often manual, involving paper forms, phone calls, and fax machines. This can lead to delays, lost information, and inefficiencies. The traditional methods of patient referral are riddled with inefficiencies, such as time-consuming manual procedures, unclear correspondence, and delays in scheduling, which ultimately lead to patient discontent and an excessive administrative load on medical professionals. The process is vital for ensuring continuity of care, particularly when patients need specialized services that their current provider cannot offer. Historically, patient referrals have been managed through manual processes, which include phone calls, faxed documents, and handwritten notes. However, the traditional methods have several limitations. Manual processes are time-consuming, leading to delays in patient care. Handwritten notes and verbal communications are prone to errors and miscommunication. Paper documents can be lost or misplaced, resulting in lost information. Poor communication between referring and receiving providers can lead to fragmented care.

Patients are gradually choosing to receive readily available treatment in urgent care facilities that are conveniently located near their homes, places of employment, or places of education. This allows patients to have relatively easy access to healthcare without the inconvenience of appointments, which are frequently scheduled weeks or months in advance. This shift is being caused by patients' common problems with scheduling an appointment with a primary doctor when needed or in a timely manner. However, the relevance of primary care physicians is diminishing, which makes it challenging for various treating physicians to keep a relatively comprehensive medical record for every patient. As a result, patients must repeat a lot of information.

Healthcare facilities are often faced with staff shortages and work overloads, which can have an impact on the collection of health data and early diagnosis. Thus, a heretofore unaddressed need exists in the industry to address the aforementioned deficiencies and inadequacies.

### SUMMARY

In one aspect of the present disclosure, a system for standalone automated patient referral management is provided. The system includes an intake module that accepts and process patient referrals from diverse referral communication channels as entry points for patient referrals and also may retrieve patient information of a patient. The system further includes a processing module that undertakes the analysis of the patient information to pinpoint a healthcare provider based on at least one of a requirement and a preference of the patient, and a schedule availability of the healthcare provider. The system further comprises a scheduling module configured to schedule an appointment. The scheduling module also engages in dynamic communication between the patient, a referring entity and the healthcare provider. Additionally, the system includes a feedback module that dispatches feedback to the referring entity, and may offer a report on an outcome of the appointment.

Potentially, the intake module includes a natural language processing (NLP) module to extract information from conversational speech, that extracted information includes at least one of a patient demographic, a clinical procedure, and an insurance detail. The intake module may further include a healthcare provider interaction module configured to accept a patient referral from the referring entity. The healthcare provider interaction module may also communicate with the healthcare provider to identify a schedule availability of the healthcare provider.

Potentially, the processing module leverages real-time data from at least one of a hospital EHR system and a directory to facilitate a match between the patient and the healthcare provider. The system may also include a matching algorithm configured to match the patient with the healthcare provider based on a criterion including at least one of a specialty, the schedule availability of the healthcare provider, and the preference of the patient

Further potentially, an AI Virtual Healthcare Assistant with an intake unit and a scheduling unit employs NLP to interpret and process natural conversational language to extract and process patient information from communication between the patient and at least one of a referring entity and a healthcare provider. The AI Virtual Healthcare Assistant may additionally include a data store module, an external source module, and a recognition module. The recognition module may have a text-to-speech conversion sub-module configured to deliver medical information, to adjust speech rate and pitch, and to provide an output in a language based on the preference of the patient.

The system also includes a learning and adaptation module configured to provide secure access to historical clinical data of the patient to inform and guide a care management protocol.

Particularly, the system utilizes a healthcare provider matching algorithm to match patients with a healthcare provider based on criteria, including at least one of a specialty, an availability, and a patient preference.

In some embodiments, the scheduling module schedules an appointment through natural language communication, and confirms the appointment with the patient and the healthcare provider.

In yet another embodiment, the feedback module includes a feedback generation engine configured to communicate with an EHR system and to provide an update on the patient referral.

In another aspect, a method for automatically managing patient referrals is disclosed. The method includes the step of using a computerized device having at least one non-transitory memory and at least one processor capable of executing instructions stored in the memory. The method also includes receiving a patient referral from at least one referral communication channel, including email, fax, phone, an electronic health record (EHR) system, and a web submission. The method further includes extracting data from the received patient referral using optical character recognition (OCR). The extracted data includes patient information of a patient. The method further includes processing the extracted data using an AI Virtual Healthcare Assistant to validate and enrich the data. Additionally, the method includes analyzing the patient information to determine a healthcare need of the patient. The method further includes matching the patient with a healthcare provider using a matching algorithm based on the analyzed patient information. The method further includes using the AI Virtual Healthcare Assistant to identify a preference of the patient, to identify a schedule availability of the healthcare provider, and to schedule an appointment based on the preference and the schedule availability. Additionally, the method includes confirming the appointment with both the patient and the healthcare provider. The method also includes sending a confirmation and a reminder to the patient and the healthcare provider regarding the appointment. The method further includes generating a feedback report. Additionally, the method includes updating the electronic health record (EHR) of the patient with the appointment and a feedback, wherein the feedback may include an outcome of the appointment. The method may also include communicating pre-appointment information to the patient through the AI Virtual Healthcare Assistant, wherein the pre-appointment information includes a detail of the appointment.

Additional aspects of the method may incorporate the at least one referral communication channel being at least one of an email, a fax, a phone message, the electronic health record (EHR) of the patient, and a web submission. Further, the extracting step further may comprise using an OCR engine to convert at least one of printed text and handwritten text to machine-readable text. The step of processing the extracted data may also include enriching the data with the machine-readable text. The method may further include using a learning and adaptation module to securely access historical clinical data of the patient to inform and to guide a care management protocol. The communicating pre-appointment information to the patient step may further comprise using the Virtual Healthcare Assistant to deliver medical information, adjusting at least one of a speech rate and a pitch, and providing an output in a language based on the preference of the patient. Additionally, the feedback may further comprise at least one of a patient satisfaction survey result, a treatment outcome, a diagnosis, a treatment plan, and a follow-up action.

In yet another aspect, a computer-implemented method for automatically managing patient referrals is provided. The method includes the steps of using a computerized device having at least one non-transitory memory and at least one processor capable of executing instructions stored in the memory. The method further includes receiving a patient referral using a healthcare provider interaction module. Additionally, the method includes extracting from the patient referral, using an optical character recognition engine, referral information comprising at least one of a healthcare need and an identity of at least one of a patient, a referring entity, and a healthcare provider. The method steps also include validating the referral information with the referring entity and enriching the referral information based on an EHR of the patient using an AI Virtual Healthcare Assistant. The method further includes steps of capturing a schedule availability of the healthcare provider using an AI Virtual Healthcare Assistant, acquiring a preference of the patient using a patient interaction module, and matching the patient and the healthcare provider using the healthcare need, the EHR of the patient, the preference of the patient, and the schedule availability of the healthcare provider. Further, the method steps include selecting an appointment using the preference of the patient and the schedule availability of at the healthcare provider, confirming the appointment with the patient using the patient interaction module, and reminding the patient of the appointment using the patient interaction module. The method also includes acquiring feedback comprising at least one of a patient satisfaction survey result, a treatment outcome, a diagnosis, a treatment plan, and a follow-up action. Further, the method includes generating a feedback report based on the feedback and updating the EHR of the patient with the feedback report.

The method extracting step may also include using the optical character recognition engine to convert to machine-readable text at least one of printed text and handwritten text from a physical document. The method confirming step may also include using the AI Virtual Healthcare Assistant to deliver medical information, adjusting at least one of a speech rate and a pitch, and providing an output in a language based on the preference of the patient.

Numerous additional features, embodiments, and benefits of the methods and system of the present disclosure are discussed below in the detailed description which follows.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

FIG. 1 is a block diagram illustrating an automated patient referral management system, in accordance with the present disclosure;

FIG. 2 is a block diagram illustrating sub-modules of AI Assistant Module for data extraction, in accordance with an embodiment of the present disclosure;

FIGS. 3A-3B illustrate a flow chart depicting the process of receiving a patient referral to provide feedback to the patient, in accordance with the present disclosure;

FIG. 4 is a block diagram illustrating an exemplary communication network of the automated patient referral management system, in accordance with the present disclosure.

FIGS. 5A-5B illustrate a flow chart depicting a computer-implemented method for automatically managing patient referrals, in accordance with the present disclosure.

Various embodiments will hereinafter be described in accordance with the appended drawings, which are provided to illustrate, and not to limit the scope in any manner, wherein like designations denote similar elements.

### DETAILED DESCRIPTION

The present subject matter is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented, and the needs of a particular application may yield multiple alternate and suitable approaches to implement the functionality of any detail described herein. Therefore, any approach may extend beyond the particular implementation choices in the following embodiments described and shown.

References to “one embodiment,” “an embodiment,” “at least one embodiment,” “one example,” “an example,” “for example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

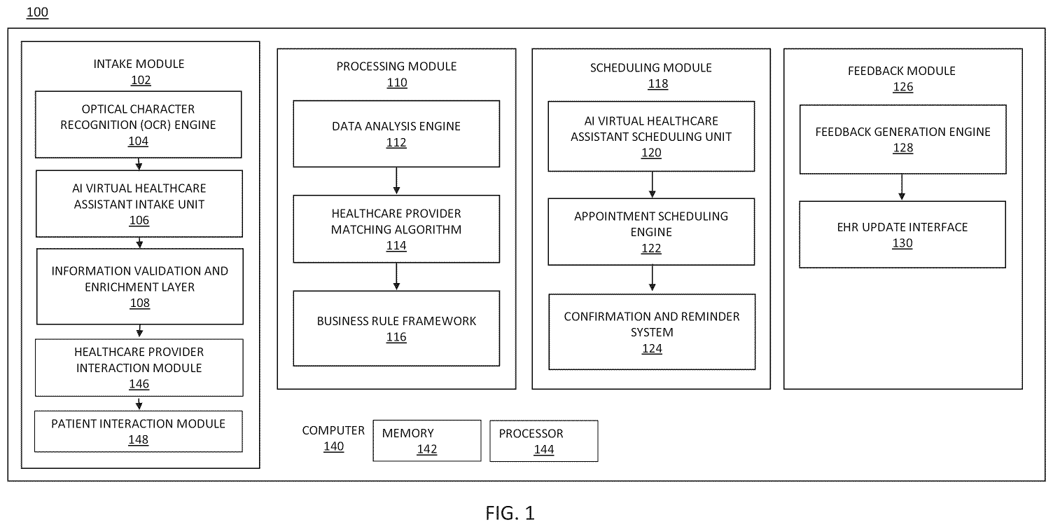

FIG. 1 is a block diagram illustrating an automated patient referral management system 100, in accordance with the present disclosure. In a preferred embodiment, the automated patient referral management system 100 is a standalone automated patient referral management that includes a computerized device 140 having a memory 142 and a processor 144. The system 100 may comprise a plurality of components including but not limited to an intake module 102, a processing module 110, a scheduling module 118, and a feedback module 126. In a preferred embodiment, the intake module 102 may be configured to capture data from a plurality of sources. The plurality of sources may comprise but are not limited to fax, phone calls, EHR notifications, and web registrations. In an embodiment, the intake module 102 may include an optical character recognition (OCR) engine 104, an AI Virtual Healthcare Assistant intake unit 106, an information validation and enrichment layer 108, a healthcare provider interaction module 146, and a patient interaction module 148. The optical character recognition (OCR) engine 104 may be configured to capture and digitize data from physical documents, such as a patient referral, patient records, and other paperwork. The OCR engine 104 may be additionally configured to convert printed or handwritten text into machine-readable text for further processing. The AI virtual healthcare assistant intake unit 106 may be configured to guide the data intake process, ensuring that information is captured accurately. The AI Virtual Healthcare Assistant intake unit 106 may be configured to enhance data accuracy and reduce manual entry errors by validating and enriching the input data. In the validation step, data integrity checks may confirm that fields like dates and phone numbers are correctly formatted, mandatory fields are filled, and consistency is maintained across records. Error detection mechanisms may correct OCR and NLP errors, while algorithms identify and merge duplicate patient records.

Following validation, the enrichment process may enhance the data by querying external databases for insurance verification (coverage and eligibility) and medical history retrieval (accesses EHR for past diagnoses, treatments, and medications). It also may add contextual information such as geolocation and demographic data, and interfaces with referring entities (referring provider or patient) to request and integrate any missing information in real-time. The AI Virtual Healthcare Assistant may be used to call and populate missing data.

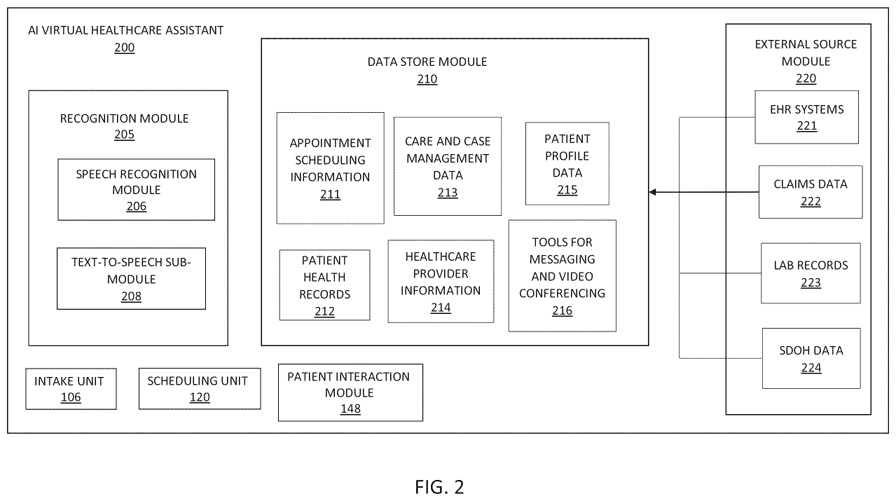

The processed data may be then normalized, aggregated, and transformed into standardized formats, ensuring consistency and readiness for further stages. In a preferred embodiment, the AI Virtual Healthcare Assistant intake unit 106 may further include natural language processing (NLP) technology (not shown in FIG. 1) to extract information from conversational speech, including patient demographics, required clinical procedures, and insurance details. In some embodiments, the AI Virtual Healthcare Assistant 200 may include a plurality of additional modules as illustrated in FIG. 2. In a preferred embodiment, the plurality of sub-modules 200 may include but are not limited to a recognition module 205, a data store module 210, and an external source module 220.

The data store module 210, in a preferred embodiment, may be a comprehensive repository that manages and stores a wide array of healthcare-related data, ensuring efficient scheduling, secure storage, and compliance with healthcare regulations. The data-store module 210 may handle a plurality of information such as appointment scheduling information 211, including available time slots, appointment requests, and confirmations, facilitating interaction between patients and healthcare providers. The data store module 210 may be further adapted to store patient health records 212, encompassing demographic details such as name, age, gender, and contact information, as well as medical history, including past illnesses, surgeries, medications, allergies, and family medical history. Patient health records may include vital signs like blood pressure, heart rate, temperature, and respiratory rate, which are recorded alongside laboratory test results, treatment plans, appointment details, and insurance information. The data store module 210 may be further adapted to store care and case management data 213 that includes but is not limited to care coordination details, case summaries, health assessments, care team information, and performance metrics, which may ensure that patients receive appropriate and well-coordinated care. Furthermore, the data store module 210 may be adapted to store a plurality of healthcare provider information 214 that includes provider profiles, healthcare provider availability, and consultation requests. The data-store module 210 may be configured to manage appointment scheduling based on healthcare provider availability, to handle a consultation request, and may include tools for messaging and video conferencing 216, thereby facilitating effective communication and collaboration among healthcare providers and patients. In some embodiments, the data store sub-module 210 may be further adapted to store an additional patient profile data 215 comprising detailed profile information, to track symptoms over time, to record medication details, and to note communication preferences, thereby enabling personalized healthcare support and services.

The external source module 220 may be adapted to integrate the system with a plurality of external data sources, to provide a comprehensive view of patient health and enhance care delivery. In an embodiment, the plurality of data sources may include electronic health record (EHR) systems 221, which supply detailed patient health records encompassing interactions, diagnoses, treatments, and outcomes, thus facilitating informed decision-making by healthcare providers. The plurality of external data-sources further may include claims data 222 from insurance providers that helps in identifying appropriate treatments based on the patient's medical history and insurance coverage. The claims data 222 may be used to monitor patient progress and track treatment effectiveness. The plurality of external data-sources further may include lab records 223 that contribute diagnostic information, including blood tests, imaging results, and other tests, which aid in accurate diagnoses and the development of treatment plans. The AI Virtual Healthcare Assistant 200 may leverage lab records 223 to alert patients and provide assistance to improve healthcare delivery. Additionally, the plurality of external data-sources may include social determinants of health (SDOH) data 224, which may include factors such as housing stability, food security, transportation access, and social support networks. The SDOH data 224 may be incorporated to enhance care delivery. The AI Virtual Healthcare Assistant may use this SDOH data 224 to tailor care plans to address specific social needs, refer patients to community resources, and engage patients in discussions about their social determinants of health. This comprehensive integration of external data sources may allow healthcare providers to gain a holistic view of a patient's health and well-being, thereby enabling more personalized and effective care.

The recognition module 205 may be adapted to process the data collected from users via the intake module 102 of system 100 to convert said data into patient details and referral information. In a preferred embodiment, the recognition module 205 may include a speech recognition sub-module 206, which may convert spoken words into text using speech recognition algorithms. The recognition module 205 may be configured to analyze audio input to identify words and phrases, considering factors such as accents, background noise, and speech patterns. By utilizing natural language understanding algorithms, the recognition module 205 may extract meaning from the text by parsing it to identify keywords, entities, and intents, ensuring high accuracy and reliability in converting speech to text. The recognition module 205 may integrate with the data store module 210 and external source module 220 to accurately evaluate the referral information. The recognition module 205 further may include a text-to-speech conversion sub-module 208 that may convert text-based responses or information into spoken language. The text-to-speech conversion sub-module 208 may use algorithms to generate natural-sounding speech, mimicking human speech patterns, intonations, and accents, thereby creating a more engaging and human-like interaction with users. The text-to-speech conversion sub-module 208 further may customize the delivery of medical information clearly and understandably, adjusting speech rate and pitch based on user preferences, and may support multiple languages to enable communication in the user's preferred language. The text-to-speech conversion sub-module 208 may enhance accessibility for users with visual impairments or reading difficulties by providing audio output and may integrate with other modules of the VHA system to provide spoken responses based on a patient preference, thereby generating speech in real-time for responses to user queries or requests.

To train the VHA, the VHA may collect interaction data from conversations with patients, which includes textual or voice input data, patient responses, timing of interactions, and preferred communication channels. It also may gather data on patient compliance, such as whether they followed through with appointments or medication after the interaction. The collected data may be structured into a format suitable for machine learning (ML) models. This may involve transforming voice data into text (using speech-to-text algorithms) and tagging data with relevant labels (e.g., appointment scheduling, medication reminders). Data may be obtained directly from patient interactions via the VHA interface and from historical clinical data securely accessed with patient consent.

Training may be accomplished in a multi-step process, including preprocessing, feature extraction, model selection, training, and evaluation and adjustment. For preprocessing, raw interaction data may be cleaned and preprocessed. For voice data, speech-to-text conversion may be applied. Data may be normalized (e.g., converting all text to lowercase) and tokenized into manageable pieces. For feature extraction, NLP techniques may be used to extract relevant features from the interaction data, such as keywords indicating patient preferences or concerns. Model selection may be based on the nature of the data and the task (e.g., preference learning), to select appropriate ML models. For dynamic preference learning, models like LSTM (Long Short-Term Memory) networks or Transformer-based models might be used due to their ability to understand context over time. The selected models may be trained on the characterized data. For preference learning, a Reinforcement Learning approach could be used where the model receives rewards based on positive outcomes (e.g., a patient confirming an appointment time as convenient). Models may be evaluated using data not previously presented to the model during training. Performance metrics might include accuracy in predicting patient preferences and satisfaction scores from follow-up surveys. Based on evaluation results, models may be fine-tuned.

The VHA may use a hybrid AI architecture combining rule-based systems for structured tasks (e.g., appointment scheduling protocols) and machine learning models for understanding and adapting to patient preferences and behaviors. Key algorithms include Natural Language Processing (NLP) for understanding patient queries and responses, and Reinforcement Learning (RL) for dynamically adjusting communication strategies based on feedback.

As the VHA interacts with patients in real time, it may continually analyze responses and outcomes to learn and adjust its strategies. For instance, if a patient frequently reschedules appointments suggested in the morning, the VHA may learn to prioritize afternoon slots for this patient. Patients can provide direct feedback on their preferences (e.g., “I prefer text messages over calls”), which may be immediately incorporated into the model's understanding of that patient. The learning models may be periodically retrained on new data collected from interactions to refine their understanding and adapt to changes in patient preferences or behaviors.

To provide personalized health recommendations or assistance, the Virtual Healthcare Agent (VHA) may process and analyze a variety of data inputs, leveraging advanced data analytics and machine learning techniques. This process may involve several steps, from collecting and preparing data to analyzing it and generating actionable insights. The steps may include data collection, data preparation, data analysis, generating outputs, and continuous learning and adaptation.

The VHA may collect data inputs to understand each patient's unique health context and preferences. Data inputs may include patient-provided information such as basic demographics, health history, lifestyle choices, and specific health concerns or symptoms reported by the patient. Data inputs may also include historical clinical data such as previous diagnoses, lab results, medication history, and treatment outcomes. Behavioral data inputs may be included, that is information on the patient's interaction with the healthcare system, such as appointment attendance, medication adherence, and response to past recommendations. For some patients, data inputs may include data from wearable devices or home monitoring systems that provide real-time data on vitals like heart rate, blood pressure, activity levels, and sleep patterns.

Before analysis, the collected data may undergo preprocessing to ensure it is clean, complete, and structured for analysis. This may involve data cleaning, normalization, and integration. Data cleaning may be described as removing or imputing missing values, correcting errors, and eliminating duplicate records. Normalization may include standardizing values (e.g., converting all temperatures to the same unit) to enable accurate comparisons. Integration may involve combining data from different sources into a unified format, creating a comprehensive patient profile.

With prepared data, the VHA may apply machine learning models and algorithms to analyze the information and derive personalized insights. This may include pattern recognition, risk assessment, and recommendation systems. Pattern recognition may involve using algorithms to identify patterns or trends within the data, such as signs of emerging health issues or factors contributing to better health outcomes. Risk assessment may include applying predictive models to assess the patient's risk of developing specific conditions based on their health data and broader population health trends. Recommendation systems may leverage machine learning to generate personalized health recommendations. This could range from lifestyle modifications (e.g., diet, exercise) to suggesting specific medical check-ups or interventions.

Based on the analysis, the VHA generates outputs in the form of personalized health recommendations or assistance. These outputs are tailored to each patient's unique health profile and preferences and can include personalized health tips, care plan adjustments, and alerts and reminders. Personalized health tips may be based on identified patterns and risk assessments, offering specific advice to improve health or mitigate risks. Care plan adjustments may suggest modifications to existing care plans, such as changing medication dosages or introducing new therapies, based on the patient's progress and current health data. Additionally, alerts for preventive measures (e.g., vaccination reminders) or reminders to adhere to treatment plans (e.g., taking medication at specified times) may be sent.

The VHA may continuously update its understanding of each patient's health and preferences through ongoing data collection and analysis. Machine learning models may be retrained with new data to refine and improve the accuracy of health recommendations over time. Feedback mechanisms may allow patients to provide input on the usefulness of recommendations, further enhancing personalization. AI accelerator chips like TPUs, and neuromorphic chips can be highly beneficial. These hardware components can significantly accelerate the processing of complex AI algorithms and natural language processing (NLP) operations. The AI Virtual Healthcare Assistant may deploy TPUs to enhance the performance of NLP models and real-time conversational AI. TPUs (Tensor Processing Units) are specifically designed for accelerating machine learning workloads, particularly those involving TensorFlow. TPUs can be used to speed up the training and inference of AI models used in the Virtual Healthcare Assistant and specialist matching algorithms.

Again, referring to FIG. 1, the information validation and enrichment layer 108 of the intake module 102 may be configured to check the consistency, accuracy, and completeness of the data received from the OCR engine 104 and the AI Virtual Healthcare Assistant intake unit 106. The information validation and enrichment layer 108 may ensure that high-quality data is obtained before processing. The information validation and enrichment layer 108 may be configured to verify patient details, referral information, and other relevant data. The intake module 102 may identify that patient and referral information is collected and validated at the outset, may reduce administrative burden, minimize errors, and speed up the referral process.

The healthcare provider interaction module 146 may provide a secure portal to submit a patient referral. The intake module 102 may provide decision support tools to healthcare providers, such as clinical guidelines, drug interaction checks, and diagnostic assistance, to enhance the quality of care. The intake module 102 may validate and format the data received from providers. The patient interaction module 148 may be responsible for direct patient communication and may be configured to contact patients to arrange healthcare appointments based on the care plans and preferences of the patients. In some embodiments, the patient interaction moule 148 may receive referral-related information using at least one of but not limited to a mobile application, a patient portal, or a computer. The referral-related information may include a patient identity, a healthcare provider identity, a referring entity identity, a patient preference, an urgency, a patient medical history, and an availability. The patient interaction module may provide personal and medical information for the patient referral through intake module 102.

The healthcare provider interaction module 146 may collect data to understand healthcare providers' scheduling preferences, availability patterns, and requirements for different types of appointments. Data may be obtained through integration with healthcare provider systems for scheduling and feedback, direct input from providers, and analysis of past appointment records. Data inputs may include healthcare provider scheduling policies, appointment outcome data, and interaction feedback. Scheduling policies may include information on scheduling preferences, such as preferred times for certain types of appointments, provider availability, and time required for different appointment types. Appointment outcome data may include data on past appointments, including no-show rates, rescheduling frequencies, and patient satisfaction scores. Interaction feedback may include direct feedback from healthcare providers on the scheduling process, preferences for patient preparation, and any adjustments to scheduling practices.

The collected data may be structured into a format that facilitates analysis and model training. This format may involve encoding categorical data (e.g., appointment types), normalizing numerical data (e.g., provider availability hours), and tagging feedback for sentiment analysis.

The appointment information data structure may include several features, including a provider identity or a unique identifier for the healthcare provider, a unique identifier for a patient identity, and an appointment type reflecting a nature of the appointment (e.g., consultation, follow-up, procedure), and a scheduled date and time for the appointment. The appointment information data structure may additionally include features such as a location or channel of the appointment (e.g., in-person, telehealth) and special provider-specific instructions for the patient (e.g., fasting requirements, documents to bring).

The provider preference data structure may capture the preferences and requirements of healthcare providers regarding appointment scheduling and patient interactions. The provider preference data structure may include a unique identifier for the healthcare provider, preferred time slots for different types of appointments, expected duration for different appointment types, preferred methods and times for communication with the VHA or patients, and constraints or special conditions for scheduling (e.g., no back-to-back appointments).

Additionally, feedback data may be structured. After each interaction, feedback can be collected to refine the VHA's understanding of provider preferences and improve future interactions. This structure may include a unique identifier for the interaction, a provider ID keyed to a healthcare provider involved in the interaction, the nature of the feedback (e.g., positive, negative, suggestion), and specific comments provided by the healthcare provider.

To generate insights and analyze data, the healthcare provider interaction module 146 may rely on a blend of AI techniques, such as natural language processing (NLP, time series analysis, and reinforcement learning (RL). NLP may be used for analyzing textual feedback from healthcare providers and extracting actionable insights on preferences and requirements. Time series analysis may be used to identify patterns in provider availability and preference changes over time. An RL algorithm may be used for adapting to provider preferences by learning from the outcomes of previous appointment scheduling attempts.

Training the AI in the healthcare provider interaction module may involve several steps, including preprocessing, feature extraction, model training, and evaluation and refinement. For data cleaning and preprocessing, text data from feedback may be processed through NLP pipelines to extract relevant features, and numerical data normalized. Key features that impact scheduling preferences may be extracted, including time-of-day preferences, appointment type preferences, and any specific requirements or constraints. Separate models may be trained for different aspects of provider preferences. For example, a model may be trained to predict the best times for scheduling specific types of appointments with a provider. RL models may be trained using historical scheduling success and provider feedback as rewards. Models may be evaluated on data not previously presented to the trained model or through controlled experiments in live environments. Based on performance, models may be refined and retrained.

In operation, the healthcare provider interaction module 146 may consult the trained models to predict the most suitable times and types of appointments based on provider preferences. It may use these predictions to propose appointment options to patients. The model may be updated based on new data and feedback. For example, if a provider consistently rejects certain appointment types at specific times, the RL model may adjust its strategy to reduce such proposals.

The processing module 110 may analyze the referral-related information to identify a healthcare provider like a specialist physician based on a healthcare need of the patient, a preference, and the availability of the healthcare provider. The module may leverage real-time data from EHR systems and directories to facilitate a matching process. The processing module 110 may comprise a data analysis engine 112 that may analyze the validated data from the intake module 102, extracts information, and may identify parameters for healthcare provider matching and further processing. The processing module 110 may include analyzing the patient's medical history, referral information, and other data points. The processing module 110 may further comprise a healthcare provider matching algorithm 114 that may utilize predefined rules and criteria to match patients with a healthcare provider based on the analyzed data. The healthcare provider matching algorithm 114 may check that a patient is referred to a healthcare provider based on a medical condition or healthcare need of the patient, a specialist availability, a location, and other relevant factors. The processing module 110 further may comprise a business rule framework 116 to provide a structured set of rules and logic to govern the matching process. The healthcare provider matching algorithm 114 may operate according to policies and practices of a healthcare organization. The business rule framework 116 may be customized and updated as needed to reflect changes in referral information, regulations, and other factors. The processing module 110 may allow the healthcare provider interaction module 146 to track the status of their referrals through the processing pipeline and may enable two-way communication for additional information requests or clarifications. The patient interaction module 148 may allow patients to upload documents directly to the processing module 110. The processing module may rely on the healthcare provider interaction module 146 to enable two way communication between the system and providers.

With respect to the processing module, the communication may be between the system and referring provider or the healthcare provider. In one example, the referring entity may communicate to the System. The referring entity may submit the referral information, which is processed by the intake module and then analyzed by the processing module. In another example, the System may communicate to a Specialist Provider or healthcare professional to confirm availability, share patient details, and finalize the referral.

Tracking the status of a patient referral may involve monitoring the progress of the referral from initiation to completion. This may include referral submission, data validation and enrichment, healthcare provider matching, appointment scheduling, and feedback and updates. Referral Submission may include capturing the initial referral details from the referring entity. Data Validation and Enrichment may include ensuring the referral information is accurate and complete. Healthcare provider matching may include identifying and confirming the most suitable specialist for the patient. Appointment scheduling may include coordinating and confirming the appointment between the patient and the specialist. Feedback and updates may include providing updates to the referring provider and patient about the referral outcome and any follow-up actions.

The techniques used to accomplish tracking may include a Database Management System, an API Integration, and User Interfaces. A Database Management System (DBMS) may be used to store and manage referral data, including status updates and event logs. API Integration may include APIs to facilitate communication and data exchange between the referral management system and external systems (e.g., EHR systems, scheduling systems). User Interfaces may be intuitive user interfaces (e.g., web portals, mobile apps) for referring providers, specialists, and patients to interact with the system and track referral status.

The scheduling module 118 may be configured to manage patient appointments with healthcare providers. In a preferred embodiment, the scheduling module 118 may comprise but is not limited to an AI Virtual Healthcare Assistant scheduling unit 120 that may manage the scheduling process. The AI Virtual Healthcare Assistant scheduling unit 120 may find available appointment slots, may coordinate schedules between patients and healthcare providers, and may confirm that the appointments are booked. The scheduling module 118 may comprise an appointment scheduling engine 122 to manage the logistics of scheduling appointments. The appointment scheduling engine 122 may allocate available appointment slots based on the information provided in the healthcare provider interaction module 146 and processed in the processing module 110. The appointment scheduling engine 122 may include a plurality of factors including but not limited to an urgency of the referral, a patient preference, and healthcare provider availability to optimize scheduling. The scheduling module 118 further may comprise a confirmation and reminder system 124 to send confirmations and reminders to patients and healthcare providers about upcoming appointments. The confirmation and reminder system 124 may confirm patient appointments and may send timely reminders through a plurality of communication channels. In some embodiments, the plurality of communication channels may be at least one of SMS, email, or a phone call. The AI virtual Healthcare Assistant scheduling unit 120 may engage in dynamic three-way communication between the patient, the referring entity, and the specialist's office. The scheduling module 118 may allow the healthcare provider interaction module 146 to suggest preferred dates and times for appointments and may send confirmations and reminders to healthcare providers.

The feedback module 126 may be configured to generate feedback based on at least one of an appointment outcome and a treatment outcome, and to update the electronic health record system of the patient with new information, and to inform the patient about updates and feedback using AI Virtual Healthcare Assistant patient interaction module 148. In a preferred embodiment, the feedback module 126 may handle a follow-up and feedback process after an appointment. The feedback module 126 may check that relevant information is communicated to both the patient and the referring entity and the EHR Update interface 130 may update the electronic health record (EHR) system of the patient. The feedback module 126 may comprise a feedback generation engine 128 that is configured to generate a feedback and a summary based on an outcome of the appointment. The feedback generation engine 128 may provide structured feedback about the patient's visit, including at least one of a diagnosis, a treatment plan, and a follow-up action. The feedback module 126 may include an EHR update interface 130 that may interface with the electronic health record (EHR) system to update patient records with information from the appointment. The feedback module 126 further may include an AI Virtual Healthcare Assistant patient interaction module 148 that may communicate with the patient to inform the patient about the feedback and any next step. The AI Virtual Healthcare Assistant patient interaction module 148 may confirm the patient is aware of an outcome of their appointment and understands any further actions they may take. The outcome may include at least one of an additional appointment, a medication instruction, or a lifestyle change. The feedback module 126 may support ongoing patient care and may facilitate better clinical decision-making by updating EHR systems and providing feedback. Patients may be kept informed about their care journey which may improve compliance with treatment plans and overall satisfaction. The automated feedback and EHR system updates may reduce the administrative burden on healthcare providers, allowing them to focus more on direct patient care. Timely and accurate updates to the EHR system may ensure that the patient's medical records reflect current information.

The AI Virtual Healthcare Assistant patient interaction module 148 may collect patient feedback post-appointment to assess their experience using the feedback module 126. The AI Virtual Healthcare Assistant patient interaction module 148 may use a survey to generate a patient satisfaction survey result and gather detailed insights into patient satisfaction. The AI Virtual Healthcare Assistant patient interaction module 148 may be also configured to send automated reminders and updates about scheduled appointments directly to the patients.

To extract and process patient information from an incoming communication, which may include at least one of a referral, a patient document, and a patient satisfaction survey result, the AI Virtual Healthcare Assistant 200 may use natural language processing (NLP) in both the intake unit 106 and scheduling unit 120 to interpret and process conversational language, and may utilize a healthcare provider matching algorithm 114 to match patients with a healthcare provider based on criteria, including a specialty, an availability, and a patient preference. Through three-way communication based on natural language, the AI virtual healthcare assistant scheduling unit 120 in the scheduling module 118 may facilitate appointment arrangements and may confirm an appointment detail.

The EHR systems 221 may serve as a data source, and may provide patient information and store updates generated by the patient referral management system 100. The system retrieves patient information like a medical history, a current medication, and a previous treatment, from the EHR system. However, various external data sources as disclosed in FIG. 2, may be utilized as well, without deviating from the scope of the current disclosure. In some embodiments, the EHR system may be updated to include referral information, an appointment outcome, and a feedback, to ensure continuity of care.

The automated patient referral management system 100 according to the present disclosure may minimize administrative workload by reducing the need for manual scheduling, may enhance patient satisfaction by providing a seamless scheduling experience, may improve the utilization of healthcare resources by optimizing appointment slots, may reduce gaps in schedules, and may ensure timely care by scheduling patients with a healthcare provider.

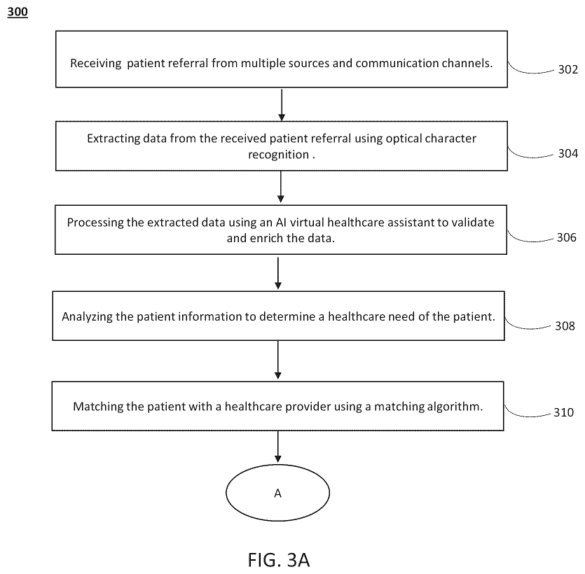

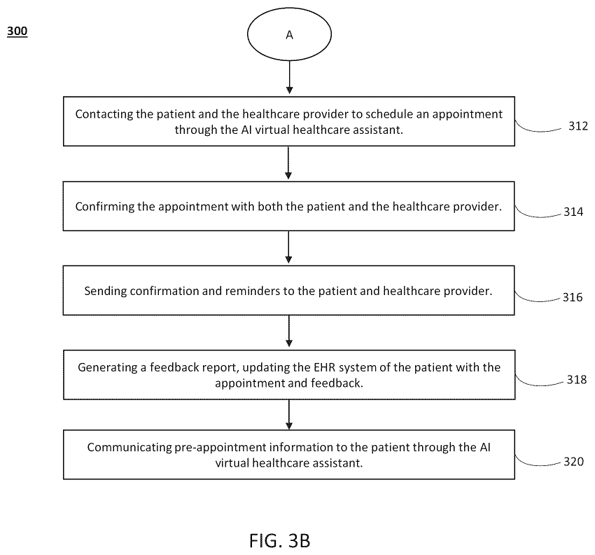

FIG. 3A-3B is a flow chart illustrating the process of receiving a patient referral to provide feedback to the patient, in accordance with the present disclosure. The method may comprise step 302 of receiving a patient referral from multiple sources and referral communication channels, including email, fax, phone, electronic health records (EHR), and web submissions. In step 304 data from the received patient referral may be extracted using optical character recognition (OCR). In step 306, the extracted data may be processed using an AI virtual healthcare assistant to validate and enrich the data. In step 308, the patient information may be analysed to determine a healthcare need of the patient. In step 310, the patient may be matched with a healthcare provider using a matching algorithm based on the analyzed patient information. In step 312, the patient and the healthcare provider may be contacted to schedule an appointment through the AI virtual healthcare assistant. In step 314, the appointment with both the patient and the healthcare provider may be confirmed. In step 316, confirmation and reminders regarding the scheduled appointment may be sent to the patient and healthcare provider. In step 318, a feedback report may be generated and the EHR system of the patient may be updated with the appointment and feedback. In step 320, pre-appointment information may be communicated to the patient through the AI virtual healthcare assistant.

In another aspect, according to the method, a patient referral may be received from a plurality of sources and referral communication channels and data may be extracted using optical character recognition (OCR) technology to digitize data from physical or scanned documents. The AI-driven assistant may gather data, which may aid in processing the extracted data. The data extracted by OCR from the patient referral may be validated and enriched to ensure accuracy and completeness before proceeding to the next stage. Further, according to the method, the validated data may be analyzed to extract patient information and understand a healthcare need of the patient. Based on the analysis, a matching algorithm may identify and select an appropriate healthcare provider for the healthcare need of the patient. The AI assistant may contact both the patient and the healthcare provider to find an appointment. The appointment may be confirmed when a mutually convenient time is determined by the AI assistant and the confirmation and reminder are sent to both the patient and the specialist. Also, according to the method a feedback report may be generated based on an outcome when an appointment is confirmed, and any follow-up actions are taken. The electronic health record (EHR) system of the patient may be updated with the appointment and the feedback report to maintain a medical history. The referring entity may be informed about an outcome of the patient referral and feedback. The AI Virtual Healthcare Assistant patient interaction module may communicate pre-appointment information and instructions to the patient. The method may leverage AI and automation to reduce manual effort, minimize errors, and enhance the overall patient experience.

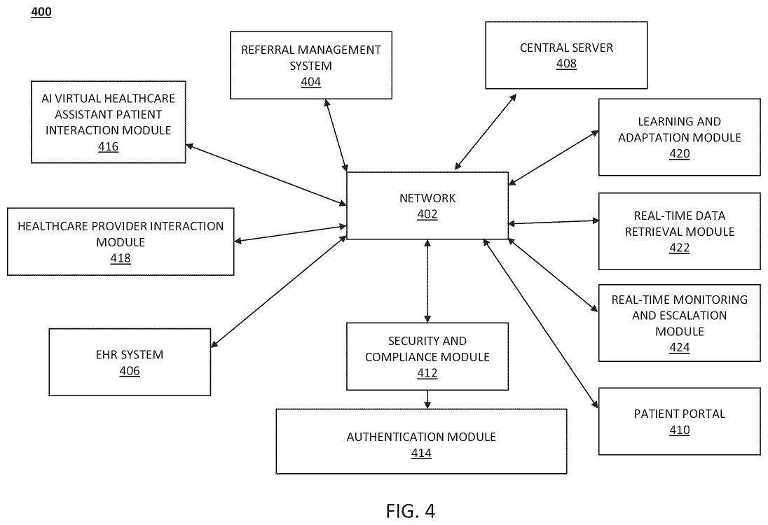

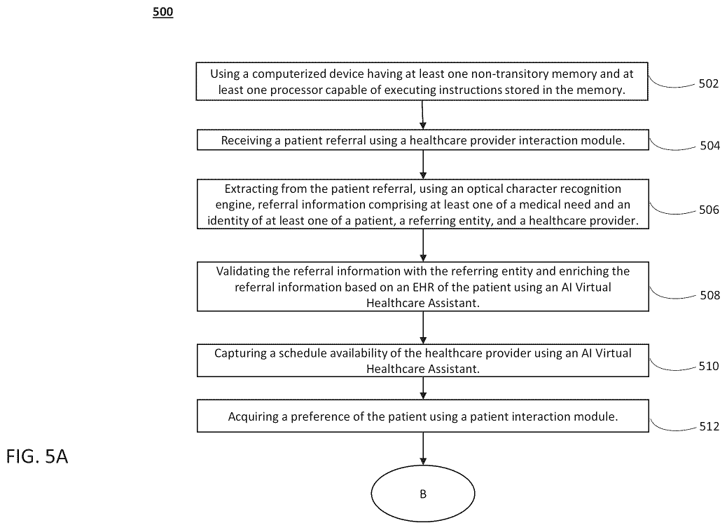

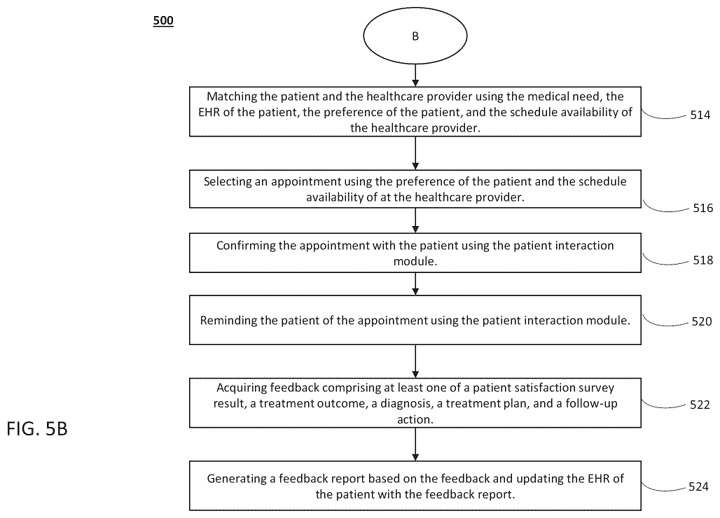

FIG. 4 is a block diagram illustrating an exemplary map of the automated patient referral management system, in accordance with the present disclosure. The patient referral management system 400 may comprise a network 402 that is configured to communicate, exchange data, and integrate between one or more components in the automated patient referral management system 400. The network 402 may facilitate communication between different modules of the patient referral management system 404 by enabling data exchange and synchronization. The network 402 also may enable seamless access and update of patient data within EHR system 406, thereby ensuring that patient records are accurate and current. The network 402 may allow healthcare providers and administrative staff to access the patient referral management system 404 from different physical locations, thereby improving flexibility and responsiveness. The automated patient referral management system 400 further may utilize cloud-based storage and computing resources to enhance scalability, data security, and accessibility. Cloud connectivity may ensure that the automated patient referral management system 400 is able to handle large volumes of data and multiple concurrent users. The network 402 also may be used to send real-time notifications, confirmations, and reminders to patients through email, SMS, or mobile apps.

The automated patient referral management system 400 further may include a central server 408 that may manage, process, and store data of the entire system. The central server may serve as the primary repository for all data related to the referral process. This central server may store and manage a wide range of data to ensure the system operates efficiently and effectively. The central server may contain patient data, referral data, appointment data, communication data, and system data.

Patient data contained in the central server may include demographic information, medical history, and current referral information. Demographic information may also refer to personal details, like name, age, gender, address, contact information and identification numbers, like social security number (SSN), patient ID, and insurance ID. Medical history data may include previous diagnoses, historical medical conditions, and diagnoses. Medical history data may also include Current and past medications, including dosages and durations, known allergies and adverse reactions, and records of previous medical procedures and surgeries. Current referral information may include the medical condition or symptoms prompting the referral, information about the primary care provider or entity initiating the referral, and specific requirements or preferences for the specialist or healthcare provider (e.g., specialty, location, gender).

Referral data in the central server may include referral details, referral status, and healthcare provider matching data. Referral Details may include a unique identifier for each referral, the date and time the referral was submitted, and the channel through which the referral was received (e.g., email, fax, phone call, EHR notification). The Referral Status may include status indicators such as “Pending,” “In Progress,” “Completed,” or “Follow-up Required” and a status history, such as a log of status changes and timestamps. Healthcare provider matching data may include information about the specialist to whom the patient is referred and criteria used for matching, such as specialty, availability, patient preferences, and insurance acceptance.

Appointment data in the central server may include scheduling information, reminders, and notifications. Scheduling information may include the scheduled date and time for the visit, an address and contact details of the healthcare provider's office, and a status indicating whether the appointment has been confirmed by the patient and healthcare provider. Reminders may include a reminder schedule, such as dates and times for sending appointment reminders to the patient and specialist. Notifications may include logs or records of notifications sent, including timestamps and delivery status.

Communication data in the central server may include interaction logs, feedback, and follow up. The interaction logs may include transcripts and logs of interactions between the VHA and patients, referring providers, and specialists and records of secure messages exchanged between the involved parties. Feedback may be from the healthcare provider and the patient. Healthcare provider feedback may include notes and recommendations from the provider following the patient visit. Patient feedback may include details on the patient's experience and satisfaction with the referral process. Follow-up may incorporate any follow-up actions, such as additional appointments or tests.

System data in the central server may include configuration, rules, and audit logs. Configuration, like system settings, may include configuration settings for the system's operation, such as notification preferences and security settings. A business rule framework may include configurable rules for specialist matching, data validation, and scheduling. The Audit logs may include access logs, or records of who accessed the system and when and action logs, like detailed records of actions taken within the system, including data modifications and status updates.

The central server 408 may serve as the backbone for data management, communication, and system operations. The central server 408 may be configured to store patient information, patient referrals, appointments, availabilities, schedules, feedback reports, and other relevant data. The automated patient referral management system 400 may perform data processing tasks, including analyzing patient information, running matching algorithms to find a healthcare provider, and generating feedback reports. The automated patient referral management system 400 may check that data stored on and transmitted through the server is encrypted to protect patient privacy and comply with regulations like HIPAA. According to the present disclosure, logs of activities and transactions may be maintained within the automated patient referral management system 400 to provide an audit trail for compliance and security purposes. The automated patient referral management system 400 further may include a patient portal 410 that may allow patients to view their patient referral, patient information, appointment, schedule, and feedback report. The automated patient referral management system 400 further may comprise an authentication module 414 that allows an authorized user to access the system, using at least one of a password, biometric, or two-factor authentication. The automated patient referral management system 400 may generate a feedback report for at least one of a patient summary, a referral efficiency metric, and a compliance report.

The automated patient referral management system 400 further comprises an AI Virtual Healthcare Assistant patient interaction module 416 that may be responsible for direct patient communication. The AI Virtual Healthcare Assistant patient interaction module 416 may be configured to contact patients to arrange healthcare appointments based on the care plans and preferences of the patients. The AI Virtual Healthcare Assistant patient interaction module 416 also may be configured to perform initial health assessments through structured questioning and send reminders for upcoming appointments and medication schedules. Patients may use the AI Virtual Healthcare Assistant patient interaction module 416 to track their health metrics like blood pressure, blood sugar levels, and exercise routines. Further, the automated patient referral management system 400 includes a healthcare provider interaction module 418 that facilitates communication with hospital front desk staff and other healthcare providers. The healthcare provider interaction module 418 may integrate with electronic health record (EHR) system 406 to ensure that healthcare providers have access to up-to-date and accurate patient information. Moreover, the automated patient referral management system 400 may include a learning and adaptation module 420 that may enable the system to improve its performance over time through learning from user interactions and feedback. The learning and adaptation module 420 may review a past interaction to identify successful communication strategies and may remember at least one of a patient preference and provider preference to tailor a future communication.

The AI VHA system may leverage historical clinical data to inform and to guide care management protocols. This process may involve several steps, from data retrieval to the application of machine learning algorithms to generate actionable insights. Informing a care management protocol may incorporate personalized recommendations and predictive modeling. Personalized recommendations may be based on the data analysis. The system may generate personalized recommendations for the patient. These recommendations may include adjustments to medication dosages, suggestions for lifestyle changes, or the need for specific medical tests or follow-up appointments. The system may use predictive modeling to assess the patient's risk of developing specific conditions or complications. This may allow a healthcare provider to take proactive measures to prevent or mitigate these risks.

Guiding a care management protocol may include protocol customization and decision support. For protocol customization, the system may customize care management protocols based on the patient's unique health profile. This may include tailoring treatment plans, scheduling regular check-ups, and setting reminders for medication adherence. For decision support, the system may provide decision support tools to healthcare providers, such as clinical guidelines, drug interaction checks, and diagnostic assistance. These tools may help providers make informed decisions about patient care.

The learning and adaptation module 420 may acquire and characterize data, apply AI architecture and algorithms, train an AI model, and improve the model. Training data may include a variety of inputs reflective of user interactions, preferences, and behaviors. The inputs may include text and voice inputs from patient interactions, including questions asked, responses given, and feedback on recommendations; behavioral data such as appointment attendance, medication adherence, and interaction times; and explicit feedback provided by users on the VHA's recommendations and responses.

Data for the learning and adaptation module 420 may be acquired through the VHA's direct interactions with users. Text and voice inputs may be captured during each interaction, while feedback mechanisms (e.g., satisfaction surveys, direct feedback options) allow users to provide insights on the VHA's performance. Additionally, integration with healthcare systems may provide access to relevant behavioral data.

The collected data for the learning and adaptation module 420 may be structured to facilitate analysis and model training. This structuring may involve converting voice data to text using speech-to-text algorithms, categorizing inputs into various interaction types (e.g., appointment setting, medication inquiries), and labeling data based on the nature of feedback (positive, negative, neutral) and specific user preferences identified.

The AI architecture of the learning and adaptation module 420 may leverage a blend of Natural Language Processing (NLP), machine learning (ML), and reinforcement learning (RL) algorithms. NLP may be used to process and understand natural language inputs, extracting relevant information and context from user interactions. ML models, particularly supervised learning algorithms, may predict user preferences and the likely success of different types of recommendations based on historical data. RL may be employed to continuously refine the VHA's decision-making process, learning from each interaction's outcomes to improve future recommendations and responses.

Training of the learning and adaptation module 420 may involve several steps, including preprocessing, feature extraction, model selection and training, and evaluation and refinement. The structured data may undergo preprocessing to clean the data and prepare it for analysis. This preprocessing may include normalizing text, handling missing values, and feature extraction. Features may be extracted from the data, such as specific keywords indicating user concerns or preferences, interaction times, and feedback sentiments. For NLP tasks, models like BERT or GPT (or their derivatives) may be trained on the text data to understand and generate human-like responses. Supervised learning models (e.g., decision trees, SVMs) may be trained on labeled data to identify user preferences and predict the effectiveness of certain responses. An RL model may be set up with states representing different interaction contexts, actions corresponding to possible recommendations or responses, and rewards based on positive user feedback. Models may be evaluated using a separate set of data not seen during training. Performance metrics (e.g., accuracy, user satisfaction scores) may guide further refinement of the models.

The learning and adaptation module 420 may continuously learn and improve. In real time, the RL model may adjust its strategy with every interaction, learning from the rewards associated with each action taken. This adjustment may allow for dynamic adaptation to individual user preferences and behaviors. Periodically, the ML and NLP models may be re-trained on new data collected since the last training cycle, incorporating fresh insights and feedback to ensure the VHA remains up-to-date. Additionally, user feedback may be solicited and analyzed, providing direct insights into the VHA's performance and areas for improvement.

The automated patient referral management system 400 further may comprise a real-time data retrieval module 422 that may retrieve the lab records, vitals, and reports of the patient, and may access and follow an established care management protocol for a patient. The real-time data retrieval module 422 ensures that patient information is updated and synchronized. The real-time data retrieval module 422 may employ machine learning algorithms to understand and categorize queries and retrieve information. A combination of Natural Language Processing (NLP) models and Information Retrieval (IR) algorithms may be used. NLP models like BERT (Bidirectional Encoder Representations from Transformers) or its variants (e.g., RoBERTa, DistilBERT) may be employed to understand the context and nuances of user queries. These models may understand natural language, making them suitable for interpreting patient or healthcare provider inquiries. Additionally, information retrieval algorithms such as TF-IDF (Term Frequency-Inverse Document Frequency), BM25, or vector search techniques using embeddings may be used to match the query's intent with the most relevant information from the database or knowledge base.

The machine learning models of the real-time data retrieval module 422 may use multiple sources of input data for training. A dataset of frequently asked questions and their corresponding answers or information sources may help the model learn the mapping between queries and the relevant pieces of information. Documents and summaries of clinical guidelines and protocols may help the model understand and retrieve medically accurate information relevant to patient care. Anonymized logs of past patient interactions, including queries made and the information retrieved may help the model understand the types of queries made and refine the retrieval process. Additionally, information on healthcare provider preferences, scheduling policies, and other relevant administrative data to aid in provider-specific queries.

The training data of the real-time data retrieval module 422 may be further categorized. The data may be labeled with tags or categories representing the type of information or response required (e.g., appointment scheduling, medication information). Text data may be preprocessed for NLP tasks, including tokenization, lemmatization, and the removal of stop words.

The training process for the real-time data retrieval module 422 may involve several steps, including preprocessing, model selection and configuration, training and fine tuning, and evaluation and iteration. The training data may undergo preprocessing to convert text into a format suitable for machine learning models. This may include cleaning the text, tokenization, and, for NLP models, and converting sentences into embeddings. To configure the NLP, a pre-trained model like BERT may be fine-tuned with the FAQs and patient interaction logs to adapt it to the healthcare context. The NLP model may be additionally trained/fine-tuned on the healthcare-related dataset, learning to understand the context and intent behind queries. For the IR part, algorithms like TF-IDF or BM25 may be configured with the training data to optimize the retrieval of relevant information based on query similarity. The IR model may be trained with the dataset to map queries accurately to the most relevant pieces of information or answers. Additionally, the models may be evaluated using a separate validation set not presented during training. Performance metrics such as accuracy, recall, and precision for information retrieval may be used to measure effectiveness. Based on evaluation results, the models may be iteratively refined and re-trained.

During operation, the real-time data retrieval module 420 processes incoming queries in real-time. Queries may be passed through the NLP model to understand the intent and context. The interpreted query may be also used by the IR algorithm to fetch the most relevant information from the database or knowledge base. The retrieved information may be presented to the user, providing immediate and contextually relevant responses.

The automated patient referral management system 400 also may comprise a real-time monitoring and escalation module 424 that may provide the automated patient referral management system 400 with the capability to monitor a call quality in real-time and escalate to a human agent if needed. When an emergency is detected, the real-time monitoring and escalation module 424 may trigger an escalation. The real-time monitoring and escalation module 424 may generate an alert and notification based on the monitored data, signaling potential issues or emergencies that require attention. The real-time monitoring and escalation module 424 may be based on artificial intelligence.

The real-time monitoring and escalation module 424 may acquire data from historical interaction logs, where calls have been manually reviewed and classified based on their outcomes (e.g., successful resolution, emergency detection, escalation due to complexity). Emergency and complex interaction data may be sourced from specific case studies or training scenarios designed to simulate these situations. Data may also be sourced from healthcare records with anonymization and privacy measures in place.

Data used to train the real-time monitoring and escalation module 424 may include quality-assessed call transcripts, emergency situation data, health status indicators, and complex interaction data. The transcripts may include transcripts of interactions that have been manually reviewed for quality, tagged with quality scores, annotated with quality scores and specific feedback on areas of improvement or excellence, and noted for any issues identified. The emergency situation data may include transcripts or records of calls identified as containing emergency situations, annotated with the specific cues or keywords that signaled the emergency. The annotations may highlight verbal and non-verbal cues indicating emergencies, distress, or urgent needs for assistance, including changes in tone, specific keywords, or phrases indicating distress, and pauses in speech. Health status indicators may include transcripts and medical records indicating normal and abnormal health status discussions, including descriptions of symptoms, expressions of concern, and questions about medications or treatments. Complex interaction data may include examples of interactions that were escalated due to their complexity, with annotations explaining the reasons for escalation.

The real-time monitoring and escalation module 424 may use structured data. Data may be structured around individual calls, with metadata including timestamps, call duration, participant IDs, and outcome tags (quality score, emergency, escalation). Textual data from transcripts may be processed into a format suitable for NLP analysis, including tokenization and tagging of relevant features. Categorical labels may indicate the presence of quality issues, emergency signals, distress indicators, and health status abnormalities.

The real-time monitoring and escalation module 424 may use AI architecture and algorithms like NLP for quality assessments, pattern recognition for emergency detection, and a complexity detection algorithm. For example, NLP models like BERT or GPT may be used to understand the content and context of interactions, or may be trained to recognize indicators of high or low-quality interactions based on the tagged transcripts. NLP models like BERT may deeply understand textual content and be capable of capturing the context and subtleties of language that indicate quality, distress, or health-related issues. Classification Algorithms (e.g., Support Vector Machines, Random Forests) may be trained to classify interactions based on the presence of specific issues or indicators. Additionally, supervised learning models may be trained on the emergency situation data to recognize specific patterns or keywords indicative of an emergency. Anomaly detection techniques may identify outliers or patterns that deviate significantly from the norm, indicating potential emergencies or complex issues not directly covered in the training set. Further, a combination of NLP for understanding the intricacies of the interaction and anomaly detection techniques may identify when an interaction deviates significantly from the norm, suggesting complexity beyond the VHA's capabilities.

Training for the real-time monitoring and escalation module 424 may involve several steps, such as preprocessing, feature extraction, model training, and evaluation and iteration. NLP models may be fine-tuned on the healthcare-specific dataset to enhance their understanding of relevant contexts. Classification models may be trained on labeled data to detect specific issues. Anomaly detection models may be trained on a broad dataset to recognize normal interaction patterns and flag significant deviations.

Call transcripts and interaction data may be preprocessed for NLP analysis, including cleaning the text, tokenization, and encoding of categorical data (e.g., outcome tags). Additionally, textual data may be vectorized to convert it into a format suitable for ML models. Features that signal call quality, emergencies, distress, health status, and complex issues may be extracted. For emergencies and complex issues, this extraction might include linguistic cues like specific phrases, sentiment analysis, patterns of speech, the urgency in the voice, or long pauses indicating confusion. A quality assessment model may be trained on quality-assessed call transcripts using an NLP model to predict call quality scores. An emergency detection model may be trained on emergency situation data using supervised learning algorithms to recognize emergency indicators. A complexity detection model may be trained on complex interaction data, combining NLP analysis with anomaly detection algorithms to flag potential complexities. Further, models may be evaluated on a validation set separate from the training data to assess their accuracy and sensitivity in detecting issues. Performance metrics (e.g., accuracy, precision, recall) may guide further refinement and re-training.

In operation, the real-time monitoring and escalation module 424 may perform real-time analysis using the trained models to perform emergency detection, complexity detection, quality monitoring, and issue detection, including detecting distress signals or health status abnormalities. For known issues, the classification models may directly identify specific indicators present in the interaction. For unforeseen issues, the anomaly detection model may flag significant deviations from normal patterns, which could indicate an emergency or complex issue. For anomaly detection, the system may analyze residuals—the differences between predicted normal behavior and actual behavior. By setting an error threshold, interactions that exhibit significant deviations (beyond this threshold) may be flagged for escalation. For known issue detection, the system may employ discriminate analysis to differentiate between various types of issues, using trained classification models to identify specific patterns associated with each issue type.

During a call, the real-time monitoring and escalation module 424 may perform real-time analysis of the interaction, using the trained models to assess quality, detect potential emergencies, and identify complexities. If the emergency detection model identifies signals of an emergency, the system may perform an escalation based on predefined protocols, including flagging the interaction for escalation or activating protocols to alert human operators or emergency services. For quality issues or detected abnormalities in health status discussions, the system might flag the interaction for follow-up or provide the user with guidance on next steps. When the complexity detection model identifies an issue as too intricate, the call may be flagged for escalation to a human operator. Additionally, throughout the interaction the quality assessment model may evaluate the call's quality, providing feedback that can be used to improve accuracy and effectiveness performance over time.

The automated patient referral management system 400 further may include a security and compliance module 412 that may protect patient data during transmission and storage and may restrict access to patient information based on roles and permissions. The security and compliance module 412 may ensure that the automated patient referral management system 400 adheres to the relevant healthcare regulations and standards. The security and compliance module 412 also may ensure that the patient information is protected from unauthorized access or breaches.

In the intake module 102, the providers and patients submit the referral information through the AI Virtual Healthcare Assistant patient interaction module 416 and the healthcare provider interaction module 418.

The patient interaction module 416 may be designed to provide contextually relevant advice and recommendations to patients while identifying patterns and trends in patient health data. This module may leverage Machine Learning (ML) and Natural Language Processing (NLP) techniques to analyze patient data, learn from interactions, and generate insights. The patient interaction module may acquire data from many sources, including patient health records, interaction logs, and feedback. Patient health records may include historical health data such as diagnoses, treatments, medication adherence, lab results, and symptoms reported by patients. The records may be obtained from EHRs. Interaction logs may be textual and, if available, voice logs of patient interactions with the VHA, including questions asked by patients and the advice provided. Additionally, patient feedback on the relevance and helpfulness of the advice and recommendations provided by the VHA may be collected through feedback mechanisms integrated into the VHA. Data privacy and security may be respected, with data anonymized and handled in compliance with healthcare regulations such as HIPAA.

The patient interaction module 416 may employ data structures such as a unified patient profile that encapsulates a patient's medical history and demographic information; interaction history, including timestamps, types of inquiries, and feedback; and a log of advice and recommendations provided, along with patient outcomes and feedback.

The patient interaction module 416 may employ a multi-layered AI architecture, integrating several algorithms to analyze data, identify patterns, and generate advice. The architecture and algorithms may include NLP Models (e.g., BERT, GPT-3) used to process and understand natural language queries from patients and to generate human-like responses. Additionally, the module may employ supervised learning models (e.g., Random Forest, Gradient Boosting Machines) to predict patient health outcomes based on historical health data and to personalize advice. Additionally, the module may employ unsupervised learning algorithms (e.g., K-Means, PCA) to identify patterns and trends in patient data, such as common symptoms or effective treatments for specific patient segments.

The patient interaction module 416 may be trained in many steps, including preprocessing, feature extraction, model training, and evaluation and iteration. In preprocessing, health records and interaction logs may be preprocessed to standardize formats and extract relevant features. Text data may also be tokenized and vectorized for NLP tasks. In feature extraction, features may be extracted from the data, including medical conditions, treatment histories, patient inquiries, and feedback patterns. In training, NLP models may be fine-tuned on interaction logs to improve their ability to understand and respond to patient queries. Training may also involve supervised learning models trained on health records and feedback data to predict health outcomes and personalize advice. Additionally, training may involve unsupervised learning models, which may analyze the entire dataset to uncover patterns and trends. Further, the models may be evaluated using a separate validation set to assess accuracy, relevance of advice, and patient satisfaction. Based on performance, models may be iteratively refined and re-trained.

In operation, the patient interaction module 416 may integrate data, perform real-time analysis, generate advice, and employ a feedback loop. To integrate data when a patient interacts with the VHA, the unified patient profile may be updated in real-time with new data from the interaction. Also, in real-time, the NLP model may process the patient's query to understand its context and intent. Additionally, supervised learning models may use the patient's profile to generate personalized advice and recommendations. Unsupervised learning models may provide real-time insights into broader trends that may be relevant to the patient's query. Based on these analyses, the patient interaction module 416 may generate contextually relevant advice, recommendations, and insights, which are communicated back to the patient through the VHA. Further, patient feedback on the advice provided may be collected and used to further refine and personalize future interactions.

The real-time data retrieval module 422 may validate and enrich the data. The automated patient referral management system 400 may process referrals using a real-time data retrieval module 422 and the healthcare provider matching algorithm 114. The automated patient referral management system 400 may monitor progress and escalates issues as needed. The scheduling module 118 may schedule an appointment based on real-time availability and predictive analytics, may send a notification, and may manage a rescheduling process. The feedback module 126 may collect feedback from both a healthcare provider and a patient and may use feedback for continuous improvement through the learning and adaptation module 420. The healthcare provider interaction module 418 may facilitate communication with providers throughout the referral process. The AI Virtual Healthcare Assistant patient interaction module 416 may keep patients informed and engaged throughout the referral process.

The learning and adaptation module 420 may continuously improve through real time learning, model retraining, and a feedback loop. The real time learning model may adjust its strategy with every interaction, learning from the rewards associated with each action taken. This may allow for dynamic adaptation to individual user preferences and behaviors. Additionally, the ML and NLP models may be periodically re-trained on new data collected since the last training cycle, incorporating fresh insights and feedback to ensure the VHA remains up-to-date. User feedback may also be continuously solicited and analyzed to provide direct insights into the VHA's performance and areas for improvement.

The training data involved in the learning and adaptation model 420 may include a variety of inputs reflective of user interactions, preferences, and behaviors. For example, the training data may include text and voice inputs from patient interactions, including questions asked, responses given, and feedback on recommendations. The training data may additionally include behavioral data such as appointment attendance, medication adherence, and interaction times. Further, the training data may include explicit feedback provided by users on the VHA's recommendations and responses.

The training data may be collected through the VHA's direct interactions with users. Text and voice inputs may be captured during each interaction, while feedback mechanisms (e.g., satisfaction surveys, direct feedback options) may allow users to provide insights on the VHA's performance. Additionally, integration with healthcare systems may provide access to relevant behavioral data.

The collected data may be structured to facilitate analysis and model training. This may involve converting voice data to text using speech-to-text algorithms. The structuring may additionally involve categorizing inputs into various interaction types (e.g., appointment setting, medication inquiries). Further, the data structuring may include labeling data based on the nature of feedback (positive, negative, neutral) and specific user preferences identified.

The learning and adaptation module 420 may leverage a blend of Natural Language Processing (NLP), machine learning (ML), and reinforcement learning (RL) algorithms within a robust AI architecture. NLP may be used to process and understand natural language inputs, extracting relevant information and context from user interactions. ML models, particularly supervised learning algorithms, may predict user preferences and the likely success of different types of recommendations based on historical data. RL may be employed to continuously refine the VHA's decision-making process, learning from each interaction's outcomes to improve future recommendations and responses.

To train the models in the learning and adaptation module 420, several training steps may be required, including preprocessing, feature extraction, model selection and training, and evaluation and refinement. In the preprocessing step, the structured data may undergo preprocessing to clean the data and prepare it for analysis. This may include normalizing text, handling missing values, and feature extraction. In feature extraction, key features may be extracted from the data, such as specific keywords indicating user concerns or preferences, interaction times, and feedback sentiments. The model selection and training steps may depend on the type of model. For example, for NLP tasks, models like BERT or GPT (or their derivatives) may be trained on the text data to understand and generate human-like responses. Supervised learning models (e.g., decision trees, SVMs) may be trained on labeled data to identify user preferences and predict the effectiveness of certain responses. An RL model may be set up with states representing different interaction contexts, actions corresponding to possible recommendations or responses, and rewards based on positive user feedback. Finally, in evaluation and refinement, models may be evaluated using a separate set of data not seen during training. Performance metrics (e.g., accuracy, user satisfaction scores) may guide further refinement of the models.

In an embodiment, the automated patient referral management system 400 may integrate with regional or national health information exchanges to facilitate data sharing across different healthcare organizations. The automated patient referral management system 400 may connect with third-party services like laboratory information systems, imaging centers, and specialty clinics in an embodiment.

The disclosed methods and systems, as illustrated in the ongoing description or any of its components, may be embodied in the form of a computer system. Typical examples of a computer system include a general-purpose computer, a programmed microprocessor, a microcontroller, a peripheral integrated circuit element, and other devices, or arrangements of devices that are capable of implementing the steps that constitute the method of the disclosure.

The computer system comprises a computer, an input device, a display unit, and the Internet. The computer further comprises a microprocessor. The microprocessor is connected to a communication bus. The computer also includes memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source, or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, “C”, “C#”, “C+”, “C++”, “Embedded C”, “Visual C++,” Java”, “Python” and “Visual Basic”. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, “iOS”, “Mac” “Unix,” “DOS,” “Android,” “Symbian,” and “Linux.”

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The claims can encompass embodiments for hardware, software, or a combination thereof.

Although few implementations have been described in detail above, other modifications are possible. Moreover, other mechanisms for performing the systems and methods described in this document may be used. In addition, the logic flows depicted in the figures may not require the particular order shown, or sequential order, to achieve desirable results. Other steps may be provided, or steps may be eliminated, from the described flows, and other components may be added to, or removed from, the described systems. Accordingly, other implementations are within the scope of the following claims.

1. A system for standalone automated patient referral management, the system comprising:
a computerized device having at least one non-transitory memory and at least one processor capable of executing instructions stored in the memory;
an intake module configured to accept and process a patient referral from a referral communication channel and to retrieve patient information of a patient;
a processing module configured to analyze patient information to pinpoint a healthcare provider based on at least one of a requirement and a preference of the patient, and a schedule availability of the healthcare provider;
a scheduling module configured to schedule an appointment and to engage in dynamic communication between the patient, a referring entity, and the healthcare provider; and
a feedback module configured to dispatch feedback to an originating entity and to output a report on an outcome of the patient referral.

2. The system of claim 1, wherein the intake module further comprises a natural language processing (NLP) module configured to extract, from conversational speech, at least one of a patient demographic, a clinical procedure, and an insurance detail.

3. The system of claim 1, wherein the intake module further comprises a healthcare provider interaction module configured to accept the patient referral from the referring entity and to communicate with the patient to arrange an appointment based on both the preference of the patient and a scheduling constraint of the healthcare provider.

4. The system of claim 1, wherein the processing module leverages real-time data from at least one of an electronic health record (EHR) and a directory to facilitate a match between the patient and the healthcare provider.

5. The system of claim 1, wherein an AI Virtual Healthcare Assistant uses NLP to interpret and process natural language to extract and process patient information from communication between the patient and at least one of the referring entity and the healthcare provider.

6. The system of claim 5, wherein the AI Virtual Healthcare Assistant further comprises a data store module, an external source module, and a recognition module having a text-to-speech conversion sub-module configured to deliver medical information, to adjust at least one of a speech rate and a pitch, and to provide an output in a language based on the preference of the patient.

7. The system of claim 1, further comprising a learning and adaptation module configured to provide secure access to historical clinical data of the patient to inform and guide a care management protocol.

8. The system of claim 1, further comprising a matching algorithm configured to match the patient with the healthcare provider based on a criterion including at least one of a specialty, the schedule availability of the healthcare provider, and the preference of the patient.

9. The system of claim 1, wherein the scheduling module is configured to arrange an appointment through natural language communication, and to confirm the appointment with the patient and the healthcare provider.

10. The system of claim 1, wherein the feedback module further comprises an integrated feedback loop configured to communicate with an EHR system and to provide an update on the patient referral.

11. A computer-implemented method for automatically managing patient referrals, the method comprising:
using a computerized device having at least one non-transitory memory and at least one processor capable of executing instructions stored in the memory;
receiving a patient referral from at least one referral communication channel;
extracting data from the received patient referral using optical character recognition (OCR), wherein the extracted data comprises patient information of a patient;
processing the extracted data using an AI Virtual Healthcare Assistant to validate and enrich the data;
analyzing patient information to determine a healthcare need of the patient;
matching the patient with a healthcare provider using a matching algorithm based on the analyzed patient information;
using the AI Virtual Healthcare Assistant to identify a preference of the patient, to identify a schedule availability of the healthcare provider, and to schedule an appointment based on the preference and the schedule availability;
confirming the appointment with the patient and the healthcare provider;
sending a confirmation and a reminder to the patient and the healthcare provider regarding the appointment;
generating a feedback report, updating an electronic health record (EHR) of the patient with the appointment and a feedback, wherein the feedback comprises an outcome of the patient referral; and
communicating pre-appointment information to the patient using the AI Virtual Healthcare Assistant, wherein the pre-appointment information comprises a detail of the appointment.

12. The method of claim 11, wherein the at least one referral communication channel comprises at least one of an email, a fax, a phone message, the electronic health record (EHR) of the patient, and a web submission.

13. The method of claim 11, wherein the extracting step further comprises using an OCR engine to convert at least one of printed text and handwritten text to machine-readable text.

14. The method of claim 13, wherein processing the extracted data further comprises enriching the data with the machine-readable text.

15. The method of claim 11, further comprising using a learning and adaptation module to securely access historical clinical data of the patient to inform and to guide a care management protocol.

16. The method of claim 11, wherein communicating pre-appointment information to the patient further comprises using the Virtual Healthcare Assistant to deliver medical information, adjusting at least one of a speech rate and a pitch, and providing an output in a language based on the preference of the patient.

17. The method of claim 11, wherein the feedback further comprises at least one of a patient satisfaction survey result, a treatment outcome, a diagnosis, a treatment plan, and a follow-up action.

18. A computer-implemented method for automatically managing patient referrals, the method comprising:
using a computerized device having at least one non-transitory memory and at least one processor capable of executing instructions stored in the memory;
receiving a patient referral using a healthcare provider interaction module;
extracting from the patient referral, using an optical character recognition engine, referral information comprising at least one of a healthcare need and an identity of at least one of a patient, a referring entity, and a healthcare provider;
validating the referral information with the referring entity and enriching the referral information based on an EHR of the patient using an information validation and enrichment layer;
capturing a schedule availability of the healthcare provider using an AI Virtual Healthcare Assistant;
acquiring a preference of the patient using a patient interaction module;
matching the patient and the healthcare provider using the healthcare need, the EHR of the patient, the preference of the patient, and the schedule availability of the healthcare provider;
selecting an appointment using the preference of the patient and the schedule availability of at the healthcare provider;
confirming the appointment with the patient using the patient interaction module;
reminding the patient of the appointment using the patient interaction module;
acquiring feedback comprising at least one of a patient satisfaction survey result, a treatment outcome, a diagnosis, a treatment plan, and a follow-up action;
generating a feedback report based on the feedback; and
updating the EHR of the patient with the feedback report.

19. The method of claim 18, wherein the extracting step further comprises using the optical character recognition engine to convert to machine-readable text at least one of printed text and handwritten text from a physical document.

20. The method of claim 18, wherein the confirming step further comprises using the AI Virtual Healthcare Assistant to deliver medical information, adjusting at least one of a speech rate and a pitch, and providing an output in a language based on the preference of the patient.
